(19) United States
(12) Patent Application Publication
(10) Pub. No.: US 2011/0163221 A1
(43) Pub. Date: Jul. 7, 2011

(54) METHOD FOR CONTROLLING DEFLECTION IN STRUCTURAL MEMBER

(75) Inventors: Takao HASEBE, Niwa-Gun (JP); Takashi NORIHISA, Niwa-Gun (JP)

(73) Assignee: Okuma Corporation, Niwa-Gun (JP)

(21) Appl. No.: 12/966,300

(22) Filed: Dec. 13, 2010

(30) Foreign Application Priority Data
Jan. 6, 2010 (JP) 2010-001465

(51) Int. Cl. F16M 11/00

(52) U.S. Cl. 248/637

(57) ABSTRACT

A method for controlling deflection caused in a structural member when a force is applied to the structural member is described. The method includes a step of generating rotation torque in the structural member in such a direction as to cancel out the force applied to the structural member. The rotation torque is generated by a motor and a load inertia applying device such as a disc connected to the rotor. A stator of the motor is connected to the structural member and the load inertia applying device applies load inertia to a rotor of the motor.

This application claims the entire benefit of Japanese Patent Application Number 2010-001465 filed on Jan. 6, 2010, the entirety of which is incorporated by reference.

### BACKGROUND OF THE INVENTION

1. Field of the Invention

The present invention relates to a method for controlling deflection caused in structural members of various machines such as machine tools.

2. Description of Related Art

In various machines including machine tools, if a movable member capable of moving along a structural member is provided, deflection may occur in the structural member due to a reaction force caused by an acceleration or deceleration of the movable member. For example, in the case of a double column machining center as an example of a machine tool, which includes: a bed, columns as a structural member which vertically extend on the bed, a horizontal cross rail bridging between the columns at front surfaces of the columns and capable of moving in the vertical direction, and a saddle with a spindle head as a moving member which is positioned at a front surface of the cross rail and capable of moving in the horizontal direction, deflection is caused in the columns by the reaction force generated when the saddle moves in the horizontal direction. This reaction force induces vibration, which may lead to loss of accuracy in the machine. Such deflection may also occur by an external force other than the reaction force generated during the movement of the movable member.

Although deflection of the structural member can be controlled by increasing the second moment of cross sectional area of the structural member itself, it leads to an increase in size and cost of the machine. With this in view, U.S. Pat. No. 5,959,427 (corresponding to Japanese Laid-open Patent Publication No. 11-329962) discloses an actuator which applies a reaction cancellation force vector (i.e., a vector having a magnitude equal to the mass of a movable member multiplied by the linear acceleration of the movable member) to a structural member supporting the movable member along an axis lying parallel to the movable member direction of travel and passing through the center of gravity of the movable member.

However, this US patent document shows a configuration in which a stage (movable member) moves on a horizontally-installed base in the horizontal direction, and the reaction cancellation force vector is applied from a side surface of the base by the actuator which is fixed outside the structural member. In the above configuration, it is difficult to adapt this actuator to a structure in which a heavy weighted movable member travels in the horizontal direction, such as a machine tool including a saddle which moves in the horizontal direction along a cross rail supported by columns. This is because a fixed member (e.g., several hundred tons of mass) which is absolutely stationary with respect to the movable member is necessarily provided adjacent to the movable member, which is difficult to realize or would otherwise lead to an increased size of the overall machine and thus to an increased manufacturing cost of the machine. The installation of the actuator is therefore attended with difficulty when adapted to a machine with a limited installation space, such as a machine tool.

In view of the above, the present invention is to provide a deflection controlling method for a structural member, which can be practiced with a compact apparatus without requiring an increase in size and cost of the apparatus and which can effectively control deflection.

### SUMMARY OF THE INVENTION

In accordance with a first aspect of the present invention, as embodied and described herein, there is provided a method for controlling deflection caused in a structural member when a force is applied to the structural member, the method comprising the step of generating rotation torque in the structural member in such a direction as to cancel out the force applied to the structural member.

According to a first preferred embodiment, in the aforementioned method, the rotation torque may be generated by a motor and a load inertia applying device, and a stator of the motor is connected to the structural member and the load inertia applying device applies load inertia to a rotor of the motor.

According to a second preferred embodiment, in the aforementioned method as set forth in the first preferred embodiment, the load inertia applying device may comprise a disc connected to the rotor.

With the configuration of the aforementioned method according to the first aspect of the present invention, a force applied to the structural member can be cancelled out by rotation torque generated in the structural member, so that deflection of the structural member can be effectively controlled. In particular, since there is no need to install a heavy fixed member or the like outside the structural member, deflection control can be realized with a compact apparatus without requiring an increase in the size and the cost.

With the configuration of the aforementioned method according to the first preferred embodiment, in addition to the advantages of the first aspect of the present invention, it is possible to apply the rotation torque to the structural member in a simple and space-saving manner.

With the configuration of the aforementioned method according to the second preferred embodiment, in addition to the advantages of the first preferred embodiment, it is possible to readily apply load inertia to the rotor within the structural member.

### BRIEF DESCRIPTION OF THE DRAWINGS

To better understand the claimed invention, and to show how the same may be carried into effect, reference will now be made, by way of example only, to the accompanying drawing, in which:

FIG. 1 is an explanatory view showing a deflection controlling method.

### DETAILED DESCRIPTION OF THE EXEMPLARY EMBODIMENT

With reference to the accompanying drawing, one exemplary embodiment of the present invention will be described.

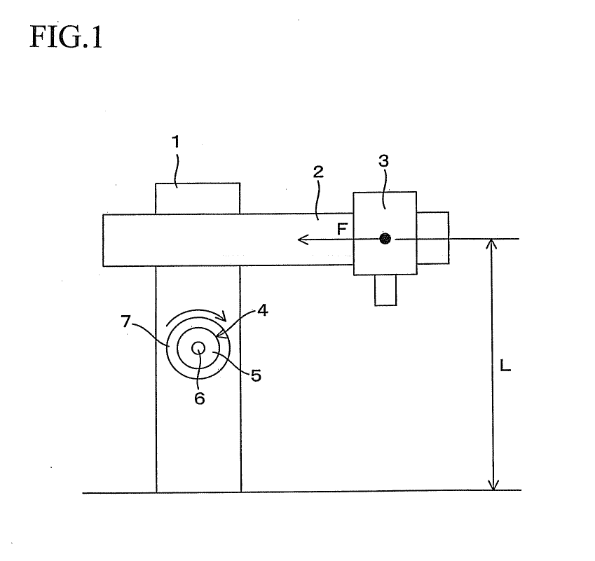

Referring to FIG. 1, the reference number 1 denotes a columnar structural member provided on a machine. A guide member 2 is horizontally provided at an upper part of the structural member 1, and a movable member 3 is supported on the guide member 2 and capable of moving in the horizontal direction. A double column machining center is given as an example of this machine. In the above configuration, the structural member 1 corresponds to a column, the guide member 2 corresponds to a cross rail, and the movable member 3 corresponds to a saddle.

A motor 4 is incorporated into the structural member 1 below the guide member 2. A stator 5 of the motor 4 is connected to the structural member 1, whereas a disc 7 having a mass as a load inertia applying device is connected to a rotor 6 of the motor 4. Therefore, when the motor 4 is driven to rotate, rotation torque can be applied to the structural member 1 through the stator 5 in a direction opposite to the rotational direction of the rotor 6 and the disc 7.

Herein, if the movable member 3 having a mass of M installed at a position separated by the distance L from a fixed end of the structural member 1 is moved with acceleration a, a force F applied to the structural member 1 is expressed as follows:

F=M*α

In this instance, deflection δ1 of the structural member 1 is expressed as follows:

δ1=F*L³/3EI

where E is Young's modulus of the structural member 1, and I is the second moment of area.

Meanwhile, deflection δ2 generated in the structural member 1 due to the rotation torque T of the motor 4 is expressed as flows:

δ2=T*L²/2EI

Therefore, if deflection δ1 is equal to deflection δ2 (i.e., δ1=δ2), then

T=2/3*F*L=(2/3*M*L)*α

Accordingly, if the motor 4 is controlled to generate torque T in proportion to the acceleration, it is possible to cancel out the deflection generated in the structural member 1 due to movement of the movable member 3.

As described above, according to the deflection controlling method described in this exemplary embodiment, since rotation torque is generated in the structural member 1 in such a direction as to cancel out a force applied to the structural member 1 due to movement of the movable member 3, the force applied to the structural member 1 can be canceled out using moment generated in the structural member 1. As a result, deflection is controlled effectively. In particular, since the deflection control can be made by controlling the motor 4 that is incorporated into the structural member 1, there is no need to install a heavy fixed member or the like outside the structural member 1. Therefore, deflection control can be realized with a compact apparatus without requiring an increase in the size and the cost.

In this exemplary embodiment, the rotation torque is generated by the motor 4 and the load inertia applying device, and the stator 5 of the motor 4 is connected to the structural member 1 and the load inertia applying device applies load inertia to the rotor 6 of the motor 4. Therefore, it is possible to apply the rotation torque to the structural member 1 in a simple and space-saving manner.

Further, as the load inertia applying device includes the disc 7 connected to the rotor 6. It is therefore possible to readily apply load inertia to the rotor 6.

Although the present invention has been described in detail with reference to the above exemplary embodiment, the present invention is not limited to the above specific embodiment and various changes and modifications may be made without departing from the scope of the appended claims.

For example, in the above exemplary embodiment, the load inertia applying device includes a disc connected to the rotor. However, the present invention is not limited to this specific embodiment, and the load inertia applying device may be realized by other means, such as a weight connected to the rotor.

In the above exemplary embodiment, rotation torque is applied to the structural member by means of the motor. However, the present invention is not limited to this specific embodiment. For example, a pair of discrete actuators may be provided inside the structural member in such a manner that the upper end portion of each actuator is pivotally connected to the structural member. Rotation torque can be applied to the structural member when the both actuators are caused to extend linearly in opposite directions.

### INDUSTRIAL APPLICABILITY

The structural member is not limited to a columnar structural member having a fixed lower end as disclosed in the above exemplary embodiment. Even if the structural member is fixed at its both ends or at its center part, deflection can be controlled using the generated rotation torque. Therefore, other than the machine tools, the present invention is applicable to various machines including a measuring apparatus and a projection exposure apparatus as disclosed in the conventional art.

1. A method for controlling deflection caused in a structural member when a force is applied to the structural member, the method comprising the step of:
generating rotation torque in the structural member in such a direction as to cancel out the force applied to the structural member.

2. The method according to claim 1, wherein the rotation torque is generated by a motor and a load inertia applying device, and wherein a stator of the motor is connected to the structural member and the load inertia applying device applies load inertia to a rotor of the motor.

3. The method according to claim 2, wherein the load inertia applying device comprises a disc connected to the rotor.
